(19) United States
(12) Patent Application Publication
(10) Pub. No.: US 2025/0308055 A1
(43) Pub. Date: Oct. 2, 2025

(54) DEVICE AND METHOD FOR OBJECT POSITION ESTIMATION

(71) Applicant: LG ELECTRONICS INC., Seoul (KR)

(72) Inventors: Sungjin KIM, Seoul (KR); Younghyeog JEON, Seoul (KR); Jeong HEO, Seoul (KR); Joongrock KIM, Seoul (KR)

(73) Assignee: LG ELECTRONICS INC., Seoul (KR)

(21) Appl. No.: 19/041,875

(22) Filed: Jan. 30, 2025

(30) Foreign Application Priority Data
Apr. 2, 2024 (WO) PCT/KR2024/004224

(51) Int. Cl. G06T 7/70; G06V 10/25; G06V 20/54

(52) U.S. Cl. CPC G06T 7/70; G06V 10/25; G06V 20/54; G06V 2201/07

(57) ABSTRACT

Disclosed is a device configured to estimate a position of an object. The device includes: an image sensor configured to acquire an image around a road; and a processor configured to detect the object from the acquired image. The processor may be configured to: determine whether a portion of a first bounding box of the detected object is located within a predetermined region of the acquired image or whether a portion of the first bounding box is outside a frame boundary of the acquired image; and update the first bounding box to a second bounding box based on that the portion of the first bounding box is located within the predetermined region of the acquired image or that the portion of the first bounding box is outside the frame boundary of the acquired image.

### CROSS-REFERENCE TO RELATED APPLICATION(S)

Pursuant to 35 U.S.C. § 119, this application claims the benefit of earlier filing date and right of priority to International Application No. PCT/KR2024/004224, filed on Apr. 2, 2024, the contents of which are all incorporated by reference herein in its entirety.

### BACKGROUND

### Technical Field

The present disclosure relates to a device and method for object position estimation, and more particular, to a technology for object position estimation through object detection in acquired images.

### Discussion of the Related Art

FIG. 1 illustrates a traffic safety service system based on communication technologies, which is one of the fields to which the present disclosure is applied. Specifically, FIG. 1 illustrates the use of vehicle-to-everything (V2X) and Soft V2X technologies.

A road side unit (RSU) 100 forwards road and traffic information, which is provided by a cooperative intelligent transport system (C-ITS) 200, to road users. The RSU 100 collects information from surrounding vehicles. In addition, the RSU 100 integrates the C-ITS 200 and Soft V2X services that use different technologies and provides information capable of predicting road collisions based on sensor information from various road surroundings including closed circuit television (CCTV).

The RSU 100 may detect various road users such as pedestrians, vehicles, motorcycles, and scooters using intelligent CCTV. The RSU 100 transmits road user detection information to surrounding users to enable collision prediction or avoidance. In addition, the RSU 100 may transmit the road user detection information to a C-ITS terminal 311 and a Soft V2X terminal 321. FIG. 1 shows that the C-ITS terminal 311 is installed on a vehicle 310, while the Soft V2X terminal 321 is installed on or located within a vehicle 320.

As described above, each of the C-ITS and Soft V2X technology is to aid in collision prediction, avoidance, or traffic accident prevention. However, the C-ITS terminal 311 and Soft V2X terminal 321 may not directly exchange information with each other. Thus, integrating the C-ITS and Soft V2X technology through the RSU 100 enables information exchange between the C-ITS terminal and Soft V2X terminal, allowing collision prediction and avoidance between a C-ITS terminal user and a Soft V2X terminal user.

To achieve the collision prediction and avoidance, it is necessary to improve object position prediction, estimation, and tracking technologies. In the present disclosure, a technology for detecting an object in an image and predicting, estimating, or tracking the position of the object will be described.

### SUMMARY

Accordingly, the present disclosure is directed to a device and method for object position estimation that substantially obviates one or more problems due to limitations and disadvantages of the related art.

The present disclosure aims to provide a method for more accurately estimating the position of an object when tracking the object in an acquired image.

Specifically, the present disclosure aims to provide a method for correcting or updating an observed value that serves as the basis for estimating the current state of an object.

It will be appreciated by persons skilled in the art that the objects that could be achieved with the present disclosure are not limited to what has been particularly described hereinabove and the above and other objects that the present disclosure could achieve will be more clearly understood from the following detailed description.

To achieve these objects and other advantages and in accordance with the purpose of the disclosure, as embodied and broadly described herein, there is provided a device configured to estimate a position of an object. The device includes: an image sensor configured to acquire an image around a road; and a processor configured to detect the object from the acquired image. The processor may be configured to: determine whether a portion of a first bounding box of the detected object is located within a predetermined region of the acquired image or whether a portion of the first bounding box is outside a frame boundary of the acquired image; and update the first bounding box to a second bounding box based on that the portion of the first bounding box is located within the predetermined region of the acquired image or that the portion of the first bounding box is outside the frame boundary of the acquired image.

In another aspect of the present disclosure, there is provided a method of estimating a position of an object. The method may include: detecting the object from an image acquired around a road; determining whether a portion of a first bounding box of the detected object is located within a predetermined region of the acquired image or whether a portion of the first bounding box is outside a frame boundary of the acquired image; and updating the first bounding box to a second bounding box based on that the portion of the first bounding box is located within the predetermined region of the acquired image or that the portion of the first bounding box is outside the frame boundary of the acquired image.

It will be understood by those skilled in the art that the above-described aspects of the present disclosure are merely part of various embodiments of the present disclosure, and various modifications and alternatives could be developed from the following technical features of the present disclosure.

The present disclosure has the following effects.

The present disclosure allows for correction or updating of a measured value in object tracking to better reflect the actual position of an object.

The present may can improve the accuracy of object position estimation in object tracking.

The effects according to the present disclosure are not limited to what has been particularly described hereinabove, and any other effects not mentioned may be clearly understood by those skilled in the art to which the present disclosure pertains from the following detailed description.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates a system in the field to which the present disclosure is applied;

FIG. 2 illustrates a flowchart for camera-based object tracking and position estimation, to which the present disclosure is applied;

FIG. 3 illustrates a procedure for object tracking based on the Kalman filter;

FIGS. 4 and 5 illustrates images captured around a road;

FIGS. 6 and 7 illustrate issues arising when an object enters a predetermined region within an acquired image and becomes obscured and solutions therefor;

FIG. 8 illustrates issues arising when an object is outside an acquired image and solutions therefor;

FIG. 9 is a diagram for explaining a method of correcting or updating a bounding box according to the present disclosure;

FIG. 10 illustrates a procedure for object tracking according to the present disclosure;

FIG. 11 illustrates an acquired image according to the present disclosure;

FIG. 12 illustrates a flowchart for object tracking or object state update according to the present disclosure; and

FIG. 13 illustrates a block diagram of an object position estimation device according to the present disclosure.

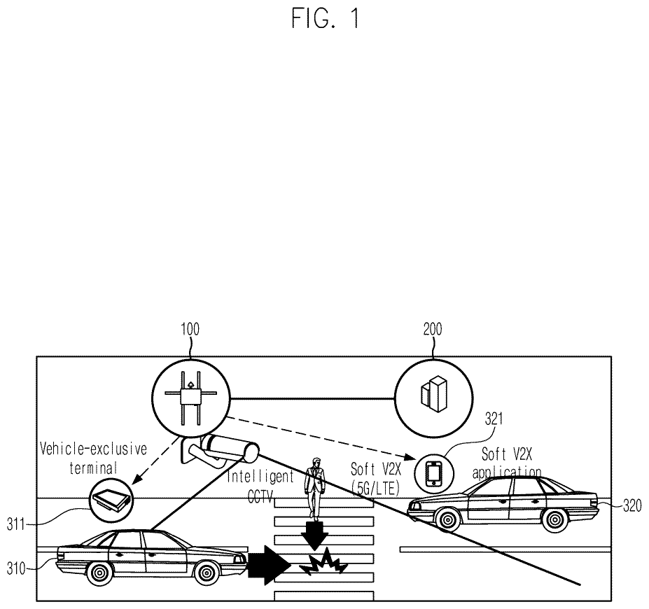

### DETAILED DESCRIPTION

Hereinafter, embodiments of the present disclosure will be described in detail with reference to the attached drawings. In this specification, the same or equivalent components will be provided with the same reference numbers, and description thereof will not be repeated. The suffixes “module” and “unit” used for the components in the following description are assigned or used for convenience of description, and do not inherently have distinct meanings or roles. The suffixes are employed solely for ease of reference and should not be considered to convey unique distinctions in meaning or function. If it is deemed that detailed descriptions of the related art obscure the gist of the embodiments disclosed in this specification, the detailed descriptions will be omitted. It should be understood that the attached drawings are merely to provide better understanding of the embodiments disclosed herein and the technical concepts of the present disclosure are not limited to the attached drawings. Thus, the present disclosure should be construed to encompass all alterations, equivalents, and alternatives within the scope of the concepts and technologies disclosed in the present disclosure.

While terms such as “first,” “second,” and so on may be used to describe various components, but the aforementioned components are not limited by these terms. The above terms are used only to distinguish one component from another.

When a component is mentioned to be “connected” or “coupled” to another component, it may be directly connected or coupled to the other component, but it should be understood that there could also be other components in between. On the other hand, when a component is mentioned to be “directly connected” or “directly coupled” to another component, it should be understood that there are no other components in between.

Unless singular expressions clearly indicate otherwise in context, the singular expressions encompass plural expressions.

In the present disclosure, terms such as “comprises” or “includes” are intended to indicate the presence of features, numbers, steps, operations, components, parts, or combinations thereof as specified in the specification, rather than to preclude the presence or possibility of one or more other features, numbers, steps, operations, components, parts, or combinations thereof.

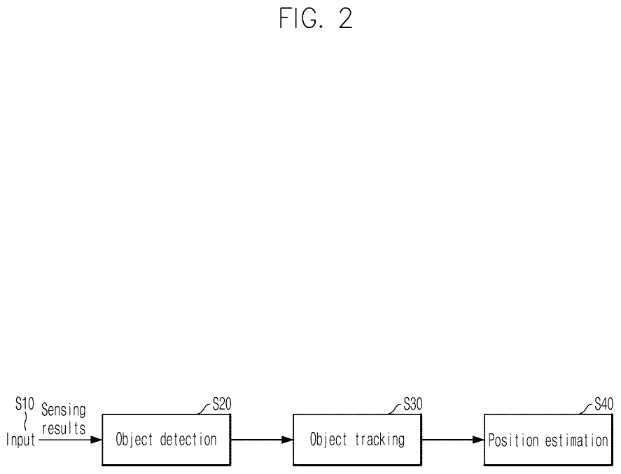

FIG. 2 illustrates a procedure in a system for camera-based object tracking and position estimation to which the present disclosure is applied.

First, an image is acquired by an image sensor such as a camera (S10).

An object is detected the acquired images (S20).

Thereafter, tracking of the detected objects is performed (S30).

Finally, position estimation is performed to acquire position information such as global positioning system (GPS) coordinates from the position of the object within the acquired image (S40).

Object tracking uses computer vision techniques to detect and track an object in an image. To this end, various algorithms are employed to detect and track moving objects. For example, key algorithms include the Kalman filter, particle filter, DeepSORT, etc. Each tracked object is assigned an identifier (ID) for individual tracking, thereby estimating the movement path and velocity of each object.

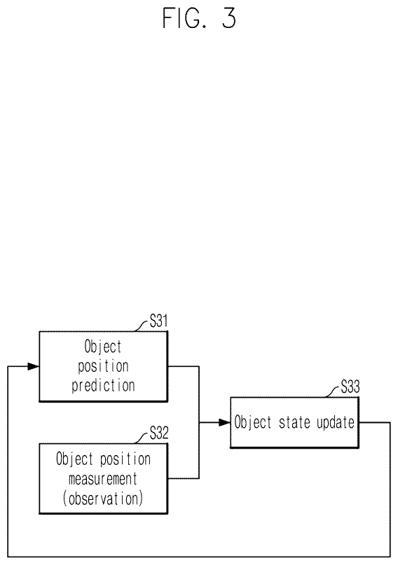

FIG. 3 illustrates a procedure for object tracking based on the Kalman filter.

The Kalman filter is used for tracking an object within an acquired image and consists of two main steps: a prediction step and an update step. By repeating these steps, the Kalman filter continuously tracks the position of the object.

The object tracking shown in FIG. 3 may be expressed as follows.

$$X = [ x\_c , y\_c , {x\_c}^{′} , {y\_c}^{′} ] \qquad Equation 1$$

In Equation 1, x_c and y_c denote the current state (optimal state) or current state (optimal state) value of the object at time t-T. Specifically, x_c and y_c denote the x-axis center point and y-axis center point of the object or bounding box, respectively. T denotes a cycle at which object tracking is repeated, involving acquiring an object position prediction state (prediction), acquiring an object position measurement value (measurement), and acquiring an object current state value (update).

In addition, x_c′ and y_c′ denote the prediction state or prediction state value of the object at time t. That is, x_c′ and y_c′ denote the x-axis center point and y-axis center point of the object or bounding box, respectively.

The current state or current state value of the object at time t-T is determined based on the prediction state values and position measurement value at time t-T. For example, the current state value of the object at time t-T is determined as the average of the prediction state value of the object at time t-T and the position measurement value of the object at time t-T.

In addition, the prediction state value of the object at time t is determined based on the current state value of the object at time t-T. In other words, the prediction state value of the object is determined based on the current state value of the object.

The position prediction state value of the object, the position measurement value of the object, and the current state value of the object are represented and acquired as information on the bounding box or center point of the object.

The object tracking according to FIG. 3 is used under the assumption that there is no change, alteration, or update in the size of the bounding box. However, if not only information on the position of the object, i.e., the coordinates of the center point, but also the width and height of the bounding box are used for the object tracking, the accuracy may be further improved.

That is, based on FIG. 3 and Equation 1, the object tracking according to the present disclosure may be expressed as follows.

$$X = [ x\_c , y\_c , w , h , {x\_c}^{′} , {y\_c}^{′} , {w}^{′} , {h}^{′} ] \qquad Equation 2$$

In Equation 2, w denotes the width of the bounding box of the current state at time t-T, h denotes the height of the bounding box of the current state at time t-T, w′ denotes the width of the bounding box of the position prediction state or position prediction state value at time t, and h′ denotes the height of the bounding box of the position prediction state or position prediction state value at time t. In this case, the position prediction state value of the object, the position measurement value of the object, and the current state value of the object are represented and acquired as information on the bounding box or center point of the object as well as the width and height of the bounding box.

The procedure shown in FIG. 3 will be described in more detail.

Using the Kalman filter, it is possible to acquire the position prediction state or position prediction state of the object (S31). In the Kalman filter, a state refers to a vector containing the position and velocity of an object to be tracked.

The position prediction state value of the object at time t is determined based on the current state (referred to as the “optimal state”) value of the object at time t-T and a system model. Here, T corresponds to a cycle at which object position prediction is repeated. The optimal state value of the object at time t-T is updated based on the position prediction state value and position measurement value of the object at time t-T. Since there is no estimated state for the object at the beginning, an initial state estimation value may be configured.

To update the optimal state value of the object, the position measurement value of the object is acquired from the acquired image (S32). The position measurement value of the object is the actual measured position of the object, that is, position information on the object acquired through the image processing technology. The position measurement value of the object may include the center coordinates of the bounding box or the center coordinates of the object (see Equation 1). In addition, the position measurement value of the object may include the width and height of the bounding box (see Equation 2).

As described above, the new optimal state value of the object is updated based on the position prediction state value and the position measurement value of the object (S33).

After the update, the procedure described above may continue to be repeated. As the procedure is repeated, the Kalman gain is determined based on an error and/or error covariance matrix between the prediction state value and position measurement value. The Kalman gain is used as a weight for adjusting the error between the prediction state value and position measurement value.

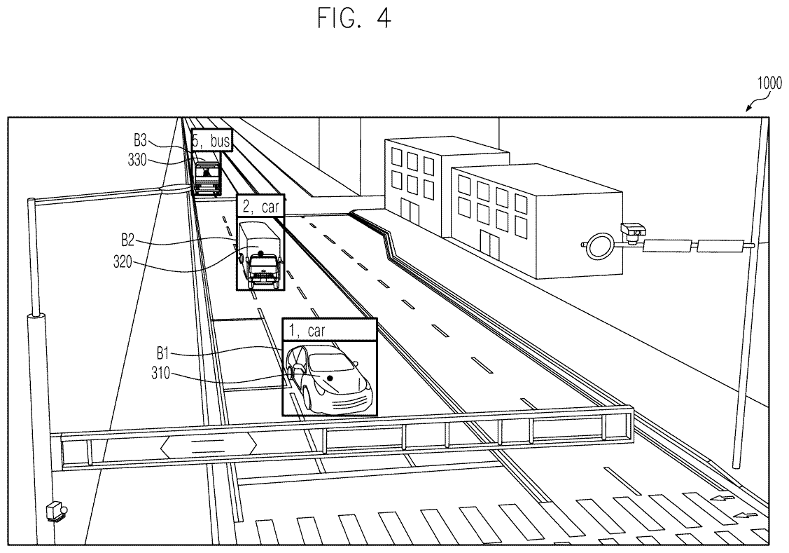

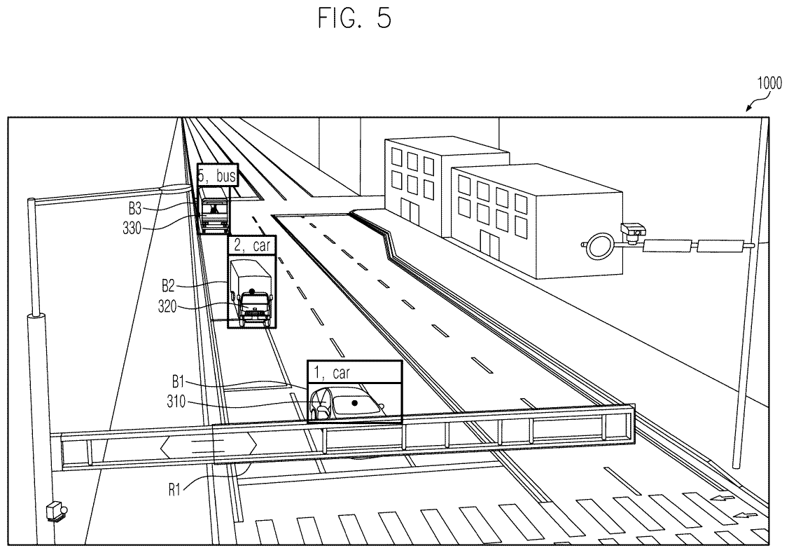

As described above, the position measurement value of the object includes the center coordinates of the bounding box or the center coordinates of the object as well as the width and height of the bounding box. However, in the scenarios shown in FIGS. 4 and 5, the object may be obscured by a specific object, which may cause the size of the current bounding box to be smaller than that of a bounding box at a previous tracking point in time. This results in errors being reflected in the position measurement value of the object. Details thereof will be described with reference to FIGS. 4 and 5.

FIGS. 4 and 5 illustrate an image 1000 captured around a road. It is assumed that the image shown in FIG. 4 is captured at time t and the image shown in FIG. 5 is captured at time t+T.

Scenes in which vehicles 310, 320, and 330 are driving on the road are shown, and bounding boxes B1, B2, and B3 are created for the vehicles 310, 320, and 330, respectively.

The images 1000 around the road are acquired through closed circuit television (CCTV) installed around the road.

Referring to FIG. 5, it is illustrated that the vehicle 310 is obscured by a region R1 in the acquired image 1000. This is because there are objects (road signs and traffic lights) closer than the vehicle 310 on the line of sight between the CCTV and the subject (i.e., the surroundings of the road). Accordingly, the bounding box B1 for the vehicle 310 in the acquired image 1000 shown in FIG. 5 is smaller than the bounding box B1 for the vehicle 310 shown in FIG. 4. As a result, even though time passes from t to t+T and the vehicle 310 is actually traveling in the driving direction, the following errors may occur: the position of the vehicle determined by the center point coordinates of the bounding box remains unchanged; and the vehicle is moving in the opposite direction. This is interpreted as an error in the position measurement value of the object in the object tracking procedure based on the Kalman filter described above, which leads to errors in the optimal state value of the object (S33 in FIG. 3).

In addition, in the scenario shown in FIG. 5, the bounding box B1 oscillates instead of remaining fixed, ultimately resulting in errors in the position measurement value of the object.

Moreover, errors in the position measurement value of the object may occur not only when the object is positioned in a specific region within the acquired image 1000 where at least a portion thereof is obscured but also when the object extends beyond the coverage area of the acquired image 1000, that is, when some parts of the object are no longer present in the acquired image 1000.

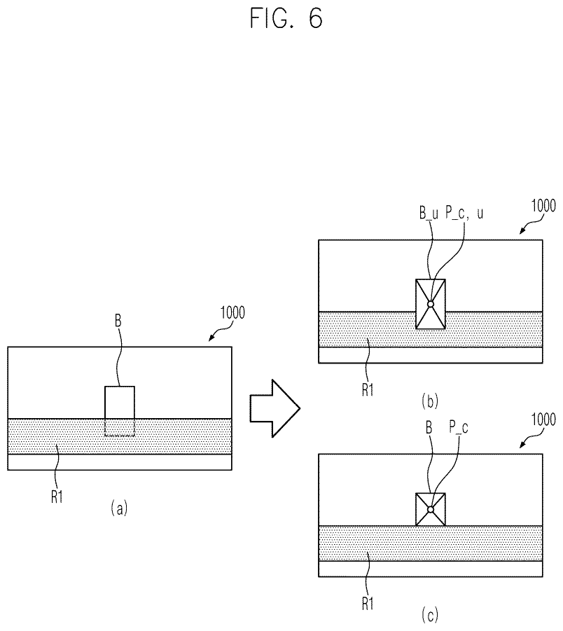

FIG. 6 illustrates issues arising when an object enters a predetermined region within an acquired image and becomes obscured and solutions therefor.

Referring to (a) of FIG. 6, a predetermined region R1 is configured within an acquired image 1000. A bounding box B for an object such as a vehicle is generated and displayed. Since at least a portion of the object is obscured in the predetermined region R1, the bounding box B may be represented as a solid line.

However, since the actual position of the object includes a portion represented as a dashed line, according to the present disclosure, the size of a bounding box B_u is corrected or updated as shown in (b) of FIG. 6. As a result, the bounding box or center point P_c,u of the object is determined based on the corrected or updated size and position of the bounding box B_u.

In addition, (c) of FIG. 6 shows a bounding box B when the bounding box acquired in (a) of FIG. 6 is not updated. In this case, the bounding box or center point P_c of the object is determined based on the size and position of the bounding box B.

Referring to (b) and (c) of FIG. 6, it may be observed that individual center points P_c and P_c,u are different from each other as described above with reference to FIG. 5. This leads to differences in the position measurement value of the object, which may cause errors in the position prediction value or optimal state value of the object.

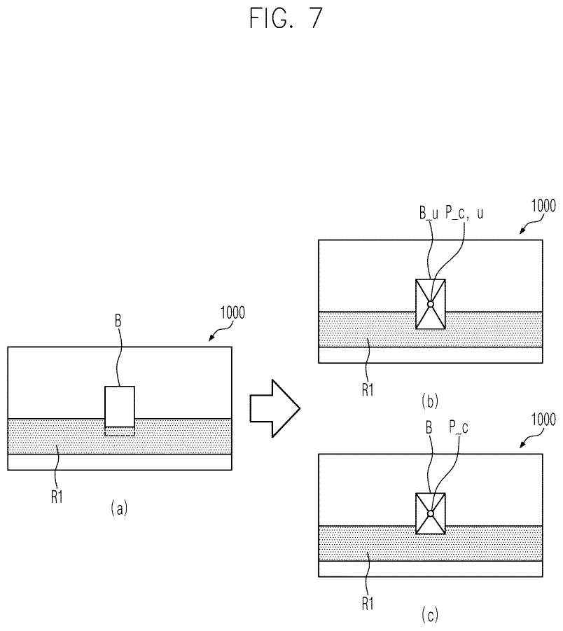

FIG. 7 illustrates a detected bounding box and correction or update thereof, which differ from that shown in (a) of FIG. 6.

Referring to (a) of FIG. 7, a predetermined region R1 is configured within ab acquired image 1000. A bounding box B for an object such as a vehicle is generated and displayed. Since at least a portion of the object is obscured in the predetermined region R1, the bounding box B may be represented as a solid line. Compared to (a) of FIG. 6, (a) of FIG. 7 illustrates a case where a portion of the bounding box B is located within the predetermined region R1.

Specifically, (c) of FIG. 7 shows a bounding box B when the bounding box acquired in (a) of FIG. 7 is not updated. In this case, the bounding box or center point P_c of the object is determined based on the size and position of the bounding box B.

On the other hand, (b) of FIG. 7 shows a bounding box B_u where correction or update is performed according to the present disclosure.

According to the present disclosure, when the detected bounding box B is in contact with or located within the predetermined region R1 of the acquired image as shown in (a) of FIG. 6 or (a) of FIG. 7, the bounding box B_u may be corrected or updated as shown in (b) of FIG. 6 or (b) of FIG. 7.

Additionally, the bounding box B may be corrected or updated even if the bounding box B is within a predetermined distance or range from the region R1. In other words, the bounding box B may be corrected or updated even when the bounding box B is not actually located in the predetermined region R1.

Whether the detected bounding box B is located in the predetermined region R1 may be determined based on position information on the bounding box B and the predetermined region R1, for example, coordinate information on the bounding box B and the predetermined region R1. In the present disclosure, the position information on the bounding box B and the position information on the predetermined region R1 in the acquired image correspond to information capable of being acquired through image processing. In addition, when the bounding box B is in contact with the predetermined region R1, it means that some coordinates of the boundary of the bounding box B are equal to the coordinates of the boundary of the predetermined region R1, while all coordinates of the boundary of the bounding box B are not equal to the coordinates inside the boundary of the predetermined region R1.

In (b) of FIG. 6, (a) of FIG. 7, (b) of FIG. 7, and (c) of FIG. 7, it is illustrated that the bounding boxes B and B_u are located in the predetermined region R1, but the predetermined region R1 and the bounding box may overlap in the acquired image.

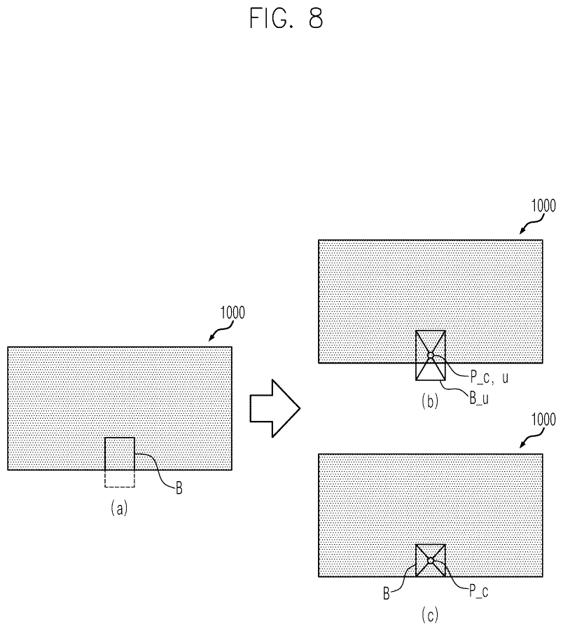

FIG. 8 illustrates issues arising when an object is outside an acquired image and solutions therefor.

In (a) of FIG. 8, it is illustrated that a portion of a bounding box B of an object is outside an acquired image 1000, which refers to a scenario where a portion of the detected object in the acquired image extends beyond the coverage area being captured by an image sensor such as CCTV.

The bounding box B for the object such as a vehicle is generated and displayed. Since at least a portion of the object extends beyond the coverage area, the bounding box B may be represented as a solid line only. According to conventional techniques, the bounding box B may be configured as shown in (c) of FIG. 8. In this case, the bounding box or center point P_c of the object is determined based on the size and position of the bounding box B.

According to the present disclosure, as shown in (b) of FIG. 8, the size of a bounding box B_u is corrected and updated. Thus, the bounding box or center point P_c,u of the object is determined based on the size and position of the corrected or updated bounding box B_u.

Referring to (b) and (c) of FIG. 8, it may be observed that the center points P_c and P_c,u are different from each other as described earlier with reference to FIG. 5. This leads to differences in the position measurement value of the object, which may cause errors in the position prediction value or optimal state value of the object.

According to the present disclosure, when the detected bounding box B is outside the boundary of the acquired image as shown in (a) of FIG. 8, the bounding box B_u is corrected or updated as shown in (b) of FIG. 8.

When the bounding box B is outside the boundary of the acquired image, it also includes a case where the bounding box B is in contact with the boundary of the acquired image. In addition, when the bounding box B is outside the boundary of the acquired image, it also includes a case where the bounding box B is within a predetermined distance or range from the boundary of the acquired image. In other words, when the bounding box B is outside the boundary of the acquired image, it includes cases where the bounding box B is positioned within the predetermined distance or range from the boundary of the acquired image without actually deviating from the boundary.

Whether the detected bounding box B is outside the boundary of the acquired image may be determined based on the bounding box B and information on the size or boundary of the acquired image, for example, coordinate information on the acquired image. In the present disclosure, information on the position of the bounding box B within the acquired image and information on the size or boundary of the acquired image may be acquired through image processing. In addition, when the bounding box B is in contact with the boundary of the acquired image it means that some coordinates of the boundary of the bounding box coincide with the coordinates of the boundary of the acquired image.

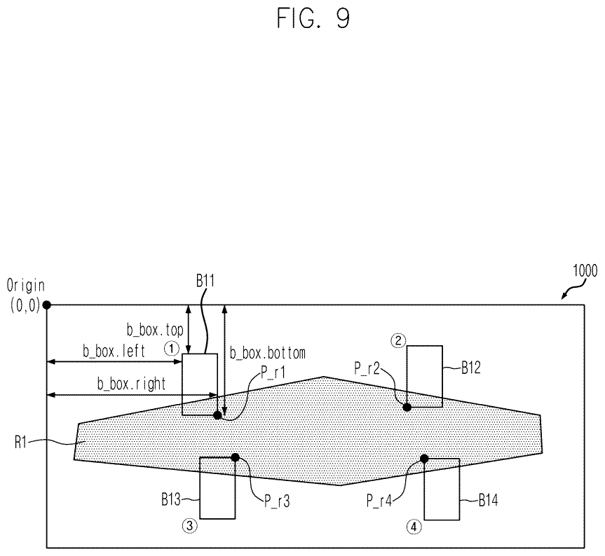

FIG. 9 is a diagram for explaining a method of correcting or updating a bounding box according to the present disclosure.

A predetermined region R1 may be configured in an acquired image 1000. If an object is positioned within the predetermined region R1, an overlapping portion between the predetermined region and object may be obscured in the acquired image 1000. The shapes, sizes, positions, or number of predetermined regions R1 in the acquired image 1000 are merely examples and do not limit the present disclosure.

A device (e.g., object position estimation device) according to the present disclosure may generate and display bounding boxes B11, B12, B13, and B14 for objects in the acquired image 1000. The bounding boxes B11, B12, B13, and B14 shown in FIG. 9 are bounding boxes generated for measured or detected objects, which are before correction or updating.

The illustrated bounding boxes are four in number, but this is for illustrative purposes and does not limit the present disclosure. In addition, it is assumed that all illustrated bounding boxes are rectangles of the same size.

Information on the bounding box may consist of position information and size information. Assuming that the top-left edge of the acquired image 1000 is the origin, the information on the bounding box information may be expressed as minimum distances b_box.top, b_box.bottom, b_box.left, and b_box.right from two lines (or two axes) (i.e., x-axis and y-axis) forming the origin to each side of the bounding box. In addition, combinations of the minimum distances to each side corresponds to information on the coordinates of each edge. In other words, assuming the bounding box is a rectangle, when b_box.top, b_box.bottom, b_box.left, b_box.right are specified, the information on the position and size of the bounding box may be determined.

In this case, b_box.top represents the minimum distance between the horizontal line passing through the origin (i.e., x-axis) and the top edge of the bounding box, b_box.bottom represents the minimum distance between the horizontal line passing through the origin and the bottom edge of the bounding box, b_box.left represents the minimum distance between the vertical line passing through the origin (i.e., y-axis) and the left edge of the bounding box, and b_box.right represents the minimum distance between the vertical line passing through the origin and the right edge of the bounding box.

Additionally, the information on the bounding box may be represented by the minimum distances from the two lines forming the origin to two corresponding perpendicular edges of the bounding box, along with the width and height of the bounding box. In other words, the information on the position and size of the bounding box may be expressed as information on the coordinates of one of the edges and the width and height of the bounding box. Specifically, the position and size of the bounding box may be expressed based on either b_box.top or b_box.bottom, either b_box.left or b_box.right, and the width and height of the bounding box. That is, the position and size of the bounding box may be expressed based on the coordinate (relative to the origin) of one of the edges of the bounding box and the width and height of the bounding box.

On the other hand, it is difficult or impossible to detect or acquire the width and height of the bounding box in the acquired image 1000 when the object is obscured by the predetermined region R1. Therefore, it is desirable to use the width and height of the bounding box detected or acquired from a pre-acquired image. Preferably, the width and height of the bounding box detected or acquired from an image where the bounding box of the object is not obscured by the predetermined region R1 may be used.

As described above, based on either b_box.top or b_box.bottom of an edge of the bounding box B11, B12, B13, or B14 that is not obscured by the predetermined region R1 and either b_box.left or b_box.right (which represent the coordinate information on the corresponding edge), the width and height of the bounding box acquired from the pre-acquired image may be used to correct or update the bounding box. In other words, the corrected or updated bounding box is acquired based on the coordinate information on the edge of the bounding box not obscured by R1 and the width and height of the bounding box acquired from the pre-acquired image.

However, it is important to determine which edge to use as a reference for correcting or updating the bounding box. This is because the position of the bounding box after the correction or update varies depending on the reference edge, which leads to differences in the position measurement value of the object. This means that the position prediction value or optimal state value of the object may also vary.

For example, the bounding box B11 will be described. There are unobscured top-left and top-right edges due to the predetermined region R1. It is assumed that the coordinates of the top-left edge are (3, 1) and the coordinates of the top-right edge are (5, 1). In addition, it is assumed that the width and height of the bounding box acquired from the pre-acquired image are 3 and 7, respectively. In this case, if the top-left edge is used as the reference edge to update the bounding box, the coordinates of the bottom-right edge of the bounding box is (6, 8). If the top-right edge is used as the reference edge to update the bounding box, the coordinates of the bottom-left edge of the bounding box is (2, 8). Thus, depending on the reference edge, the position of the corrected or updated bounding box varies.

Therefore, it is necessary to determine the reference edge to be used for correcting or updating the bounding box. Preferably, the reference edge needs to be determined as the opposite edge of the edge that penetrates the deepest into the predetermined region R1.

The procedure for correcting or updating the bounding box is briefly summarized as follows.
a) Detect the bounding box
b-1) Determine the edge of the detected bounding box that is located within the predetermined region R1
b-2) If a plurality of edges are located within R1, select one specific edge (edge that penetrates the deepest into R1)
c) Determine the opposite or diagonal edge of the selected edge as the reference edge
d) Correct or update the bounding box based on the reference edge

Among the above steps, all steps except for b-2) have been explained. Thus, step b-2) will be described. In step b-2), the selected edge is defined as a “base edge.”

It is assumed that the edges located within the predetermined region R1 are determined. Referring to FIG. 9, for the bounding box B11, the two edges at the bottom (i.e., the bottom-left edge and the bottom-right edge) are located within the predetermined region R1.

For each of the two bottom edges, a side or line (or straight line) connected to or formed with a neighboring edge that is not located in the predetermined region R1 is acquired. The length of the acquired side or line within the predetermined region R1 is measured. An edge with the longest length of side or line is selected as the base edge.

A step of acquiring the reference edge or base edge, particularly, step b-2), is necessary when two edges of a first bounding box are located in the predetermined region R1 on the assumption that the bounding box is a rectangle. If only one edge of the rectangle is located within the predetermined region R1, the corresponding edge is determined as the base edge, while an edge located diagonally to the base edge may be determined as the reference edge. If only three edges of the rectangle are located within the predetermined region R1, there is only one edge that is not located within the predetermined region R1. Thus, the corresponding edge may be determined as the reference edge.

Even when the first bounding box is in contact with the predetermined region R1, if one of the edges of the first bounding box is in contact with the predetermined region R1, the corresponding edge may be determined as the base edge. If two edges of the first bounding box are in contact with the predetermined region R1, one of the two edges may be determined as the base edge. An edge located diagonally to the determined base edge may be determined as the reference edge. If three edges of the first bounding box are in contact with the predetermined region R1, the edge that is not in contact with the predetermined region R1 may be determined as the reference edge.

For the bounding box B11 in the top-left corner of FIG. 9, the two bottom edges are located in the predetermined region R1. The object position estimation device detects the bounding box B11 from the acquired image (a). The object position estimation device determines the two edges of the bounding box B11 located in the predetermined region R1 (b-1). Then, the object position estimation device selects P_r1 among the two edges as the base edge (b-2). Details of the selection process may be found in the stated content. The object position estimation device determines an edge located diagonally to the base edge or not adjacent to the base edge as the reference edge (c). The object position estimation device may correct or update the bounding box based on information on the coordinates of the reference edge and information on the width and height of the bounding box, which is pre-acquired (d). The pre-acquired width and height information on the bounding box corresponds to values acquired from previous object position estimation. Preferably, the information includes information on the width and height of the bounding box acquired when the object is not obscured by the predetermined region R1.

For the bounding box B11, the minimum distance from the reference axis to each side may be determined as follows by using the top-left edge as a reference. In this specification, the minimum distance may be expressed in units of coordinate values.

$$B\_box . left = b\_box . left$$

$$B\_box . top = b\_box . top$$

$$B\_box . right = b\_box . left + pre\_b . box . width$$

$$B\_box . bottom = b\_box . top + pre\_b . box . height$$

Here, “b_box” denotes the minimum distance between the reference axis and the corresponding side of the bounding box detected from the acquired image, and “b_box.right” denotes the minimum distance between the right side of the bounding box and the reference axis (i.e., vertical line passing through the origin).

In addition, “B_box” denotes the minimum distance between the corresponding side of the corrected or updated bounding box and the reference axis, and “B_box.right” denotes the minimum distance between the right side of the corrected or updated bounding box and the reference axis (i.e., the y-axis) (that is, the x-coordinate value of the top-right or bottom-right edge). For the bounding box B11, information on the right and bottom sides is acquired from information on the top and left sides (i.e., the minimum distance from each axis) and information on the width and height of the bounding box.

In other words, if the coordinates of the top-left edge of the bounding box (b_box.left, b_box.top) that is not located in the predetermined region R1 are known, it is possible to acquire information on the updated bounding box from the information on the width and height of the bounding box, which is pre-acquired.

For a bounding box B12 in the top-right corner, the bottom-right edge becomes the base edge P_r2, and accordingly, the top-right edge becomes the reference edge. Therefore, the minimum distance from the reference axis to each side may be determined as follows.

$$B\_box . right = b\_box . right$$

$$B\_box . top = b\_box . top$$

$$B\_box . left = b\_box . right - pre\_b . box . width$$

$$B\_box . bottom = b\_box . top + pre\_b . box . height$$

For a bounding box B13 in the bottom-left corner, the top-right edge P_r3 becomes the base edge, and the bottom-left edge becomes the reference edge in a similar way to the correction or update of the bounding boxes B11 and B12 described above. Thus, the minimum distance from the reference axis to each side may be determined as follows.

$$B\_box . left = b\_box . left$$

$$B\_box . bottom = b\_box . bottom$$

$$B\_box . right = b\_box . left + pre\_b . box . width$$

$$B\_box . top = b\_box . bottom - pre\_b . box . height$$

For a bounding box B14 in the bottom-right corner, the top-left edge P_r4 becomes the base edge, and the bottom-right edge becomes the reference edge in a similar way to the correction or update of the bounding boxes B11 and B12 described above. Thus, the minimum distance from the reference axis to each side may be determined as follows.

$$B\_box . right = b\_box . right$$

$$B\_box . bottom = b\_box . bottom$$

$$B\_box . left = b\_box . right - pre\_b . box . width$$

$$B\_box . top = b\_box . bottom - pre\_b . box . height$$

To represent the position of a bounding box, another method may be used. For example, the relative coordinates of each edge from the origin of the bounding box may be used. The present disclosure is not limited to methods of representing the position of a bounding box.

FIG. 9 provides no explanation for a case where portions of the first bounding box are outside the frame boundary of the acquired image or a case where portions of the object are outside the frame boundary of the acquired image (that is, a case where only parts of the object are within the frame boundary of the acquired image).

Hereinafter, update to a second bounding box when portions of the first bounding box or object are outside the frame boundary of the acquired image will be described.

In this case, a procedure for correcting or updating the bounding box is defined as follows.
e) Detect whether portions of the bounding box or object are outside the frame boundary of the acquired image
f) Determine one of the edges of the detected bounding box within the frame boundary of the acquired image as the reference edge
g) Correct or update the bounding box based on the reference edge

Assuming that the first bounding box is a rectangle and does not rotate within the acquired image, two adjacent edges of the first bounding box are always outside the frame boundary of the acquired image. Therefore, handling of the first bounding box differs slightly when one of the edges of the first bounding box is positioned within the predetermined region R1. Details thereof will be described.

When a portion of the detected object is outside the frame boundary of the acquired image, the bounding box may only be detected and generated within the frame boundary. Therefore, the object position estimation device may determine whether the portion of the object is outside the frame boundary of the acquired image or whether the bounding box is in contact with the frame boundary by assessing whether the size of the bounding box is smaller than the size of a pre-acquired bounding box (e). Subsequently, the object position estimation device may select either one of the two edges of the bounding box within the frame boundary of the acquired image as the reference edge. If the object position estimation device is capable of acquiring the movement direction of the object over time, the acquired movement direction may be used to select the reference edge. Preferably, an edge located further back in the movement direction may be selected as the reference edge. For example, for the first bounding box detected in the acquired image, if the first bounding box moves diagonally towards the bottom right direction and is outside the frame boundary of the acquired image, the edge at the top left corner with respect to the acquired image may be selected as the reference edge.

However, for the first bounding box detected in the acquired image, if the first bounding box moves only horizontally (left or right) or vertically (up or down), any one of the two edges may be selected as the reference edge.

According to the present disclosure, the bounding boxes may be corrected or updated if at least some of the detected bounding boxes B11, B12, B13, and B14 are in contact with the predetermined region R1 within the acquired image 1000. Additionally or alternatively, according to the present disclosure, the bounding box may be corrected or updated if the bounding box is positioned within a predetermined distance or range from the predetermined region R1.

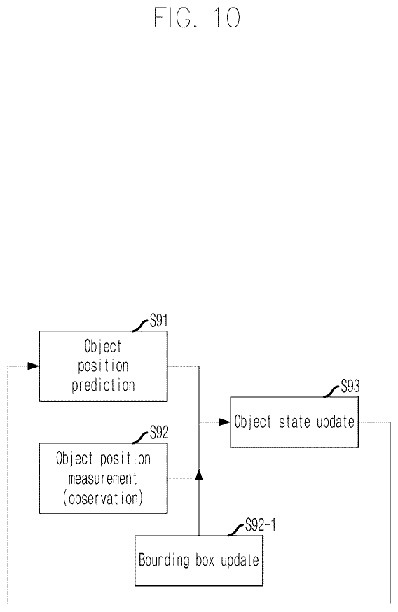

FIG. 10 illustrates a procedure for object tracking according to the present disclosure.

The procedure for object tracking shown in FIG. 10 is based on the object tracking in FIG. 3. Therefore, the explanation of the same parts as described in FIG. 3 is omitted.

As described above, the object tracking according to the present disclosure includes corresponding or updating a bounding box (S92-1). Additional information required for object tracking includes information on the width and height of the bounding box in the current state or predicted state of an object. Therefore, the object tracking according to Equation 3 is used in the present disclosure.

The correction or update of the bounding box (S92-1) may be performed in the following cases: when at least some portions of the bounding box of the object is located within a predetermined region of an acquired image, when the bounding box is in contact with the predetermined region or positioned within a predetermined distance or range from the predetermined region, or when the bounding box of the object is in contact with the boundary of the acquired image.

In other words, the technology proposed in the present disclosure enables the representation or acquisition of the position prediction state value, position measurement value, and current state value of the object based on not only information on the center point of the bounding box or object but also the width and height of the updated bounding box.

The object tracking according to the present disclosure includes updating the bounding box of the object or measurement value related thereto. Thus, even if a portion of the object is obscured or disappears in the acquired image 1000, the accuracy of object position tracking may be guaranteed.

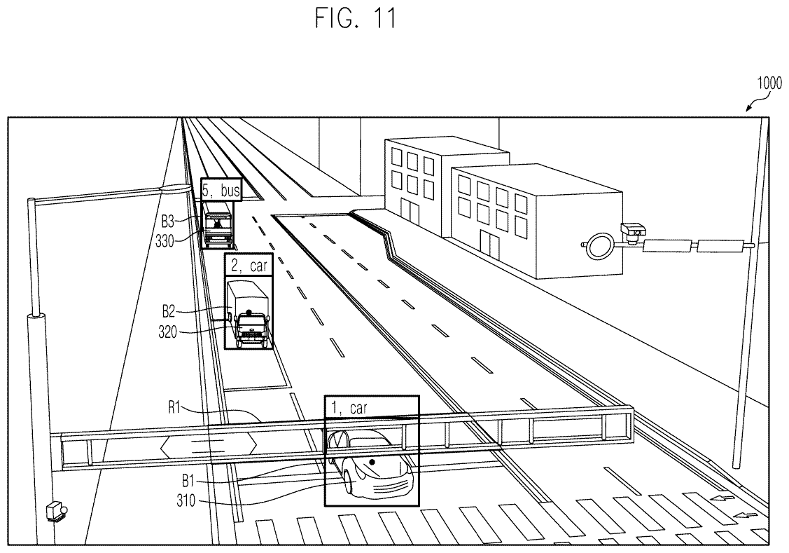

FIG. 11 illustrates an acquired image 1000 according to the present disclosure. In FIG. 11, it is observed that even if an object 310 is obscured by a predetermined region R1, the size or position of a bounding box B1 remains unchanged based on to the correction or update of the bounding box B1 described above. In FIG. 5, since the object is obscured by the predetermined region R1, only a portion of the bounding box that is not obscured by the predetermined region R1 is generated and displayed.

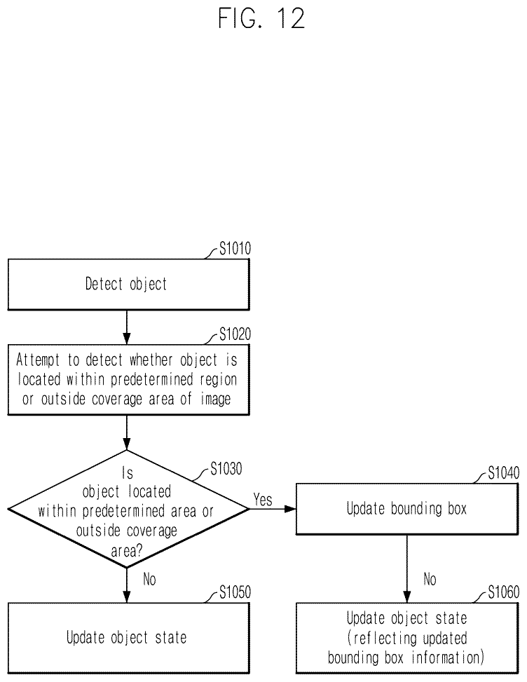

FIG. 12 illustrates a flowchart for object tracking or object state update according to the present disclosure. The object tracking or object state update may be performed by an object position estimation device or a processor included therein. For simplicity of explanation, the procedure will be described as being performed by the object position estimation device.

The procedure in FIG. 12 is initiated after acquisition of the position prediction state value of an object detected from an image acquired by the object position estimation device. As described above, the object tracking is performed by sequentially repeating the acquisition of the (initial) position prediction state value of the object, the acquisition of the position measurement value of the object, and the acquisition of the current state value of the object based on the position prediction state value and position measurement value. FIG. 12 focuses on the acquisition of the position measurement value of the object and the acquisition of the current state value of the object based on the acquired measurement value.

The object position estimation device may detect the object from the acquired image (S1010).

The object position estimation device may attempt to determine whether the detected object is positioned within a predetermined region or extends beyond the coverage area of the acquired image (S1020).

Determining whether the detected object is positioned within the predetermined region or extends beyond the coverage area of the acquired image is performed to determine whether a bounding box needs to be updated.

When the bounding box needs to be updated (i.e., when the detected object is positioned within the predetermined region or extends beyond the coverage area of the acquired image), the object position estimation device may correct or update the bounding box (S1040). The correction or update of the bounding box may be based on the content described above with reference to FIGS. 6 to 9.

Then, the object position estimation device may determine the position measurement value of the detected object based on the corrected or updated bounding box (hereinafter referred to as the position measurement value based on the updated bounding box).

The object position estimation device may update the current state value (or optimal state value) of the object based on the position measurement value based on the updated bounding box (S1060). Updating the current state value of the object includes acquiring the current state value of the object based on the position measurement value based on the updated bounding box and the most recent prediction state value of the object. For example, the current state value of the object may be determined as the average of the position measurement value based on the updated bounding box and the most recent prediction state value of the object.

When the bounding box does not need to be updated (i.e., when the detected object is not positioned within the predetermined region or does not extend beyond the coverage area of the acquired image), the object position estimation device may update the current state value (or optimal state value) of the object based on the position measurement value based on the bounding box that is not updated (S1050).

Although not shown, the object position estimation device may acquire the next position prediction state value of the object based on the updated current state value of the object.

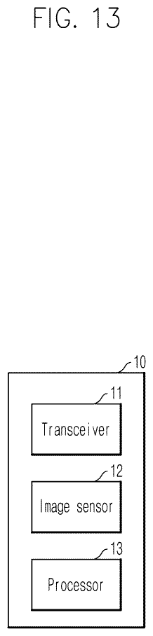

FIG. 13 illustrates a block diagram of an object position estimation device 10 according to the present disclosure.

The object position estimation device 10 may include: a transceiver 11 configured to transmit and receive messages or data; an image sensor 12 configured to acquire an image around a road; and a processor 13 configured to process received messages or data, transmit the processed messages or data, and process the acquired image.

In some embodiments, the object position estimation device 10 may include either the transceiver 11 or image sensor 12. That is, the object position estimation device 10 may include the transceiver 11 and processor 13 or the image sensor 12 and processor 13.

The processor 13 may determine whether an object detected from the acquired image is located within a predetermined region of the acquired image or whether a portion of the object is outside the acquired image or the frame boundary of the acquired image. This is to confirm the necessity for correcting or updating a bounding box of the detected object.

Alternatively, the processor 13 may detect whether at least a portion of a first bounding box of the object detected from the acquired image is located within the predetermined region of the acquired image. This may be determined by whether one of the edges of the first bounding box is located within the predetermined region. The case where at least the portion of the first bounding box is located within the predetermined region may encompass a case where the first bounding box is in contact with the predetermined region.

Alternatively, the processor 13 may compare the size of the bounding box of the object in the acquired image with the size of a pre-acquired bounding box. By comparing the sizes of the bounding boxes, the necessity for correcting or updating the bounding box of the detected object may be checked.

Depending on the necessity for correcting or updating the bounding box, the processor 13 may be configured to update the first bounding box of the object detected from the acquired image to a second bounding box.

The first bounding box corresponds to a shape for specifying the position of the object in the acquired image based on an object detection model or algorithm. The first bounding box is automatically generated without considering whether at least a portion of the detected object is obscured by the predetermined region R1 as shown in FIG. 6, 7, or 9 or whether a portion of the detected object is outside the acquired image as shown in FIG. 8. To enhance the accuracy of object position estimation in the above cases, the present disclosure proposes the second bounding box or update to the second bounding box.

Here, the predetermined region includes a region in which at least the detected object is not detected within the acquired image due to being obscured by another stationary object.

Based on information on the width and height of the bounding box of the detected object, which is pre-acquired, and information on the first bounding box, the processor 13 may generate the second bounding box for the detected object. Here, the information on the first bounding box includes information on the position of at least one edge of the first bounding box (i.e., two-dimensional coordinate values with respect to a specific point (origin) within the acquired image). At least one edge should not be located within the predetermined region R1 or outside the acquired image.

In some embodiments, the processor 13 may not display the first bounding box on the acquired image.

The generation of the second bounding box may include acquiring the coordinates of the second bounding box for the object located within the predetermined region, based on the pre-acquired width and height of the bounding box of the object with respect to the reference edge of the first bounding box of the object, which is not located in the predetermined region R1.

The reference edge may be located diagonally to one edge selected from among the edges of the first bounding box located within the predetermined region. The selected edge of the first bounding box may include an edge lying on a line with a neighboring edge not located within the predetermined region among the edges of the first bounding box located within the predetermined region, where the line has the longest length within the predetermined region. For example, P_r1, P_r2, P_r3, or P_r4 shown in FIG. 9 corresponds to the selected edge for determining the reference edge.

Alternatively, the generation of the second bounding box may include acquiring the coordinates of the second bounding box based on the pre-acquired width and height of the bounding box of the object with reference to the reference edge of the first bounding box located within the frame boundary of the acquired image.

The center point of the second bounding box may differ from the center point of the first bounding box. Alternatively, at least one of the four edges of the second bounding box may differ from the four edges of the first bounding box.

The processor 13 may be configured to determine the current state value of the object by combining the most recent position prediction state value of the object and the position measurement value based on information on the second bounding box. The current state value of the object may be used in determining a next position prediction state value.

The processor 13 may be configured to determine the current state value of the object based on information on the coordinates of the center point of the second bounding box and information on the width and height of the second bounding box.

The processor 13 may be configured to transmit a traffic safety-related message to a user or user terminal within a predetermined distance from at least one of a position corresponding to the second bounding box, a position corresponding to the position measurement value of the object based on the second bounding box, or a position corresponding to the position prediction state value based on second bounding box.

According to the present disclosure, it is possible to obtain a more accurate position measurement value or position prediction state value for an object by updating a bounding box (i.e., based on a second bounding box). As a result, selecting a user or user terminal that needs to receive traffic safety-related messages may become more precise. For example, referring to FIG. 6, according to the conventional method, users who are located at a certain distance from the center point P_c of the bounding box B in (c) of FIG. 6 are target recipients of traffic safety-related messages. However, according to the present disclosure, users who are located at a certain distance from the center point P_c,u of the bounding box B_u in (b) of FIG. 6 become target recipients of traffic safety-related messages. In other words, there is a difference corresponding to the distance difference between the two center points P_c and P_c,u, and as a result, users incapable of receiving traffic safety-related messages in the prior art are now allowed to receive the traffic safety-related messages according to the present disclosure. In urgent situations (for example, when a vehicle in the bounding box is approaching a crosswalk and a user is crossing the crosswalk), if the bounding box is partially obscured by the predetermined region R1, the present disclosure may enable transmission of a traffic-related message to the user.

The traffic safety-related message may include information on the position of the object. The information on the position of the object may include at least one of the position prediction state value of the object, the position measurement value of the object, or the current state value of the object. Alternatively, the information on the position of the object may include the average thereof. The traffic safety-related message may include not only the information about the position of the object but also at least one of the velocity of the object and the movement direction of object.

The processor 13 may be configured to transmit information on the position corresponding to the second bounding box or information on the position corresponding to the position prediction state value based on the second bounding box to other servers such as a C-ITS server through the transceiver 11.

Further, the operations, processes, and so on described above with reference to FIGS. 2 to 12 but not mentioned in FIG. 13 may also be performed by the processor 13.

In another aspect of the present disclosure, the above-described proposals or inventive operations may also be provided as code capable of being implemented, performed, or executed by a “computer” (i.e., a comprehensive concept including a system-on-chip (SoC) or a processor (or microprocessor), a computer-readable storage medium including the aforementioned code, or a computer program product. The scope of the present disclosure may be extended to the code, the computer-readable storage medium including the code, or the computer program product.

The exemplary embodiments of the present disclosure have been provided to enable those skilled in the art related to the present disclosure to implement and practice the present disclosure. Although the above description has been provided with reference to the exemplary embodiments of the present disclosure, it will be understood by those skilled in the art that the present disclosure as set forth in the claims below may be modified and varied in various ways. Therefore, the present disclosure is intended to provide the broadest scope consistent with the principles and novel features disclosed herein, rather than being limited to the embodiments disclosed herein.

What is claimed is:

1. A device configured to estimate a position of an object, the device comprising:
an image sensor configured to acquire an image around a road; and
a processor configured to detect the object from the acquired image,
wherein the processor is configured to:
determine whether a portion of a first bounding box of the detected object is located within a predetermined region of the acquired image or whether a portion of the first bounding box is outside a frame boundary of the acquired image; and
update the first bounding box to a second bounding box based on that the portion of the first bounding box is located within the predetermined region of the acquired image or that the portion of the first bounding box is outside the frame boundary of the acquired image.

2. The device of claim 1, wherein the predetermined region includes a region in which at least a portion of the detected object is not detected within the acquired image due to being obscured by another stationary object.

3. The device of claim 1, wherein the processor is configured to generate the second bounding box based on information on a width and height of the bounding box of the object, which are pre-acquired, and information on the first bounding box.

4. The device of claim 3, wherein generating the second bounding box comprises acquiring coordinates of the second bounding box based on the pre-acquired width and height of the bounding box of the object with respect to a reference edge of the first bounding box not located within the predetermined region.

5. The device of claim 4, wherein the reference edge is located diagonally to one edge selected from among edges of the first bounding box located within the predetermined region, and
wherein the selected edge of the first bounding box is an edge whose length within the predetermined region, when connected to a neighboring edge outside the predetermined region, is the longest among the edges of the first bounding box located within the predetermined region.

6. The device of claim 3, wherein generating the second bounding box comprises acquiring coordinates of the second bounding box based on the pre-acquired width and height of the bounding box of the object with respect to a reference edge of the first bounding box located within the frame boundary of the acquired image.

7. The device of claim 3, wherein a center point of the second bounding box is different from a center point of the first bounding box, or
wherein at least one of four edges of the second bounding box is different from four edges of the first bounding box.

8. The device of claim 1, wherein the processor is configured to determine a current state value of the object by combining a most recent position prediction state value of the object and a position measurement value of the object based on information on the second bounding box,
wherein the current state value of the object is used to determine a next position prediction state value.

9. The device of claim 1, wherein the processor is configured to determine a current state value of the object based on information on coordinates of a center point of the second bounding box and information on a width and height of the second bounding box.

10. The device of claim 1, comprising a transceiver configured to transmit a traffic safety-related message, and
wherein the processor is configured to control the transceiver to transmit the traffic safety-related message to a user or user terminal within a predetermined distance from a position corresponding to the second bounding box or a position corresponding to a position prediction state value based on the second bounding box.

11. The device of claim 1, comprising a transceiver configured to transmit information on the object, and
wherein the processor is configured to control the transceiver to transmit information on a position corresponding to the second bounding box or information on a position corresponding to a position prediction state value based on the second bounding box to a server.

12. A method of estimating a position of an object, the method comprising:
detecting the object from an image acquired around a road;
determining whether a portion of a first bounding box of the detected object is located within a predetermined region of the acquired image or whether a portion of the first bounding box is outside a frame boundary of the acquired image; and
updating the first bounding box to a second bounding box based on that the portion of the first bounding box is located within the predetermined region of the acquired image or that the portion of the first bounding box is outside the frame boundary of the acquired image.

13. The method of claim 12, comprising generating the second bounding box based on information on a width and height of the bounding box of the object which are pre-acquired and information on the first bounding box.

14. The method of claim 12, comprising transmitting a traffic safety-related message to a user or user terminal within a predetermined distance from a position corresponding to the second bounding box or a position corresponding to a position prediction state value based on the second bounding box.

15. The method of claim 12, comprising transmitting information on a position corresponding to the second bounding box or information on a position corresponding to a position prediction state value based on the second bounding box to a server.
